(19) United States
(12) Patent Application Publication
(10) Pub. No.: US 2022/0318536 A1
(43) Pub. Date: Oct. 6, 2022

(54) QR ENT. (ENTERTAINMENT) WARE

(71) Applicant: Jason Scott Delfino, Westbury, NY (US)

(72) Inventor: Jason Scott Delfino, Westbury, NY (US)

(21) Appl. No.: 17/708,305

(22) Filed: Mar. 30, 2022

Related U.S. Application Data
(60) Provisional application No. 63/170,577, filed on Apr. 5, 2021.

(51) Int. Cl. G06K 7/14

(52) U.S. Cl. CPC G06K 7/1417

(57) ABSTRACT

This disclosure relates to a closure for using QR Codes on jackets, T-shirts, and at later stage on bracelets that are for games, social entertainment and other related apps. The concept is to use and have QR codes for different wearable items like clothing and bracelets which are listed for games, videos, and entertainment. The present invention relates to provision of QR Codes on the wearable garments like jackets, T-shirts or bracelets for giving access to users to multiple services through their mobile computing devices.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The invention relates to a method for QR scanning through garment products and other related hand-associated products. The invention further relates to using QR codes, which are scan-able codes linked to the Internet or Universal Resource Locator (URL) or contact information for gaming and entertainment purposes.

The current invention is more pertinent to the concept of scanning codes for availing different web-based services and applications through mobile and related electronic computing devices. Embodiments of the inventive concept relate to a system, method, and computer-readable storage involving scanning QR codes posted on garments and hand-worn devices by users and initiating game sequences and entertainment-related applications on those QR codes.

### Discussion of Related Art

Optical readers, such as bar code readers, are now quite common. Typically, a bar code comprises a series of encoded symbols, and each symbol consists of a series of light and dark regions, typically in the form of rectangles. The widths of the dark regions, the bars, and/or the widths of the light spaces between the bars indicate the encoded information. A bar code reader illuminates the code and senses light reflected from the code to detect the widths and spacings of the code symbols and derive the encoded data.

Bar code reading type data input systems improve the efficiency and accuracy of data input for a wide variety of applications. The ease of data input in such systems facilitates more frequent and detailed data input, for example to provide efficient inventories, tracking of work in progress, etc.

Service providers, manufacturers and retailers label their products with hang-tag labels or QR codes that include logos, brand names, sizes, colors, pricing, promotions, sweepstakes, and bar codes for scanning product at the time of sale. Moreover, they need to provide detailed product information such as material composition to customers (this is often mandated by law, depending on the product).

There are a variety of commercially available QR Codes for accomplishing the linkage to products and services. The use of physical markers, such as QR (Quick Response) codes, provides businesses with various opportunities to promote products, services, events, sales, etc.

There are multiple inventions that have been enlisted in prior art which are defining the new system and procedures for the effective utilization of QR codes. For instance, System and Method for Using Intelligent Codes to Add a Stored-Value Card to an Electronic Wallet is a patent issued to Blackhawk Network Inc bearing patent no 2,013,030,4642A1. The method comprises of receiving a request to add a stored-value card to an electronic wallet via interpreting an intelligent code which directs a user to a URL for an electronic wallet website; prompting a user for credentials to enter the electronic wallet website; determining whether the stored-value card already exists in the electronic wallet; and adding the stored-value card to the electronic wallet. A system comprises a computer device to receive a request to add a stored-value card to an electronic wallet via interpreting an intelligent code which directs a user to a URL for an electronic wallet website; to prompt a user for credentials to enter the electronic wallet website, to determine possession of the stored-value card, to determine whether the stored-value card already exists in the electronic wallet, and to add the stored-value card to the electronic wallet.

Similarly, another invention bearing US Patent US2,013,025,6403A1 issued to Wendy MacKinnon Keith is a system and Method for Facilitating Secure Self Payment Transactions of Retail Goods. The disclosed herein are various embodiments for systems and methods for self-payment and verification of the purchase of retail goods and services. According to an embodiment of the invention, a method for verifying the purchase using a mobile electronic device in wireless communication with a payment verification system and a code generating system is provided, the method comprising the steps of: receiving from a consumer information identifying an item for purchase; receiving from a consumer information identifying payment means for purchasing the item for purchase; processing the information identifying the item for purchase and information identifying payment means and generating a unique QR code indicating a purchase of the item; sending the unique QR code to a mobile device for display by a consumer to the vendor of the item for purchase.

A US Patent 2,014,014,308,9A1 issued to Blackhawk Network Inc depicts a system and Method for Using Intelligent Codes in Conjunction with Stored-Value Cards. The invention discloses a system and method of transacting a prepaid product with an electronic mobile device that is used to electronically interface with a code, such as a QR code, bar code, RF signal or NFC signal, representing a prepaid product. The codes of multiple prepaid products of multiple prepaid product providers are grouped together on a single structure or in a single computer displayed in a shopping area. The electronic mobile device subsequently electronically interfaces with a point-of-sale device after electronically interfacing with said code to provide prepaid product information.

A systems and methods for using quick response codes to activate software applications bearing US Patent US20130239104A1 is issued to Symantec Corp. The invention discloses a computer-implemented method for facilitating access to shared resources within computer clusters may include (1) identifying a quick response code captured by at least one computing system, (2) identifying information encoded in the quick response code captured by the computing system, (3) determining that the information encoded in the quick response code contains an activation key that facilitates activation of a software application, then (4) applying, in response to this determination, the activation key to the software application in order to activate the software application without requiring a user of the software application to manually enter the activation key. Various other methods, systems, and computer-readable media are also disclosed.

A system and method for applying a digital signature and authenticating physical documents bearing U.S. Pat. No. 9,369,287B1 is issued to Seyed Amin Ghorashi Sarvestani. The patent discloses a system and a method for generating and authenticating a digital signature on a physical document. The system and method includes the use of a document having a code embedded therein (e.g., a Radio Frequency Identification Code and/or a Near Field Communication Code), a first user computing device having a first user application software and a code reader, a second user computing device having a second user application software and a code reader, a printer for printing a digital signature on the document, and a main application server for generating, encrypting and authenticating a digital signature, the data integrity of the document and status of the document.

Another patent proposes a System and method for processing gift cards using scannable code. A method is disclosed which blends the use of scannable codes such as a quick response (QR) codes and processing virtual gift cards. The system receives from a first device associated with a giver at a first time, a first visual scan of a code and data from a giver to identify a recipient and other parameter with a gift. The system receives from a second device associated with a recipient a second visual scan of the code. The system presents at least a second portion of data on the second device and then establishes a policy based on the data that causes the system to monitor purchases using the recipient payment account that existed prior to the first time for a qualifying purchase upon which the system applies the gift according to the policy.

A QR code is a two-dimensional barcode that can store information. By downloading an appropriate software-based reader, smartphones are able to read QR codes. Thus, smartphones can become easy-to-use and easy-to-carry QR code, readers. There are dozens of QR code reader apps available for cell phones, such as QR Droid and Quickmark Barcode Scanner.

The last 20 years have seen the entertainment and gaming industry going online and the accessibility through the Internet. The services are available through mobile and related computing devices. These services have taken a step ahead and are also available by scanning specific codes and hashtags. The user can access the entertainment and gaming services by simply checking the codes like QR Codes.

There are multiple solutions that have been presented in prior art. Within the last decade the advancement in similar field has been greatly reshaped. However, looking at the prior art in a similar field, the improvement in effective utilization of technology and user-friendliness is greatly limited. The accessibility to entertainment and gaming industry services through QR codes is a new concept but have limitations. The limitation is to have a QR Code readily available to the user irrespective of space and time. Currently, there are minimum or limited inventions available for all-time QR codes for the service, gaming, and entertainment industry.

The purpose of the present invention is to provide a system to all users to access different games, videos, and entertainment services through QR Codes. The invention will enable the users to access these services through their wearable garments and other related products using the Internet.

However, to Applicant's knowledge, none of these prior art devices is entirely suitable to meet this need. Hence, the inventor of the present invention proposes resolving and surmount existent technical difficulties to eliminate the shortcomings mentioned above of prior art.

The prior art and invention in this field have limited or not well designed. With reference to previous inventions or utility of such system associated with the current invention, this holds its uniqueness and usability in its domain. All previous embodiments in the field did not provide such facilitation, and hence the idea has its novelty.

### SUMMARY

In light of the disadvantages of the prior art, the following summary is provided to understand some of the innovative features unique to the present invention. It Is not intended to be a complete description. A full appreciation of the various aspects of the invention can be gained by taking the entire specifications, claims, drawings, and abstract as a whole.

It is therefore the purpose of the invention to alleviate at least to some extent one or more of the aforementioned problems of the prior art and/or to provide the relevant public with a suitable alternative thereto having relative advantages.

This invention relates to closures for using QR Codes on jackets, T-shirts, and later stage on bracelets for games, social entertainment, and other related apps. The concept is to use and have QR codes for different wearable items like clothing, bracelets etc., which are listed for games, videos, and entertainment.

The present invention is directed to the rise of the Internet and networked devices that have led to the ability to connect remote locations using their phones and portable devices for gaming and entertainment. The invention is based on access to gaming and entertainment sources through QR Codes embedded on their wearable garments and other items. This will allow the users to use such services without worrying about the QR codes at any time, only through the Internet's availability.

The invention's main objective is to provide a robust and straightforward solution to providing online connectivity to games and entertainment services. The invention is a method to connect to the video game and entertainment services through “QR Code”—a checkerboard pattern or matrix that is essentially a 2-dimensional barcode scanned by the player's smartphone or other portable computing devices. The player's or user's smartphone's internet connection and Internet available through wireless modes is then used to communicate the game's and entertainment data to the server. In other embodiments, the player's smartphone, using its network connection to a server via a software application or browser, using the QR code present on their garments or wearable items.

The invention has a working method to scan the QR code from the game-themed jacket or other related wearable garments with their mobile phones or connected portable computing devices. The scanning will enable the user to use the gaming and entertainment services to play games, watch videos and enjoy other entertainment sources.

It is also the object of the invention to provide assembly which is made of reliable construction and are good to use for long term.

It is also the object of the invention which embodies a technique, referred to as Secure QR Codes, which not only provides aesthetically enhanced QR codes but also allows for quick access to multiple types of entertainment activities.

It is further the objective of invention to embed a standard black and white QR code, referred to as a public QR code, and a secret QR code.

The foregoing has outlined the features and technical advantages of the present invention rather broadly so that the detailed description of the story that follows may be better understood. Additional features and benefits of the invention will be described hereinafter, which form the subject of the invention's claims. It should be appreciated by those skilled in the art that the conception and specific embodiment disclosed may be readily utilized as a basis for modifying or designing other structures for carrying out the same purposes of the present invention. Those skilled in the art should also be realized that such equivalent constructions do not depart from the spirit and scope of the invention as outlined in the appended claims. The novel features that are believed to be characteristic of the invention, both as to its organization and method of operation, and further objects and advantages will be better understood from the following description when considered in connection with the accompanying figures. However, it is to be expressly understood that each of the figures is provided for illustration and description only and is not intended to define the limits of the present invention.

This Summary is provided merely for summarizing some example embodiments to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims. In light of the disadvantages of the prior art, the following summary is provided to understand some of the innovative features unique to the present invention. It is not intended to be a complete description.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates complete view of disclosed assembly from front and back side in accordance with an embodiment of the present disclosure.

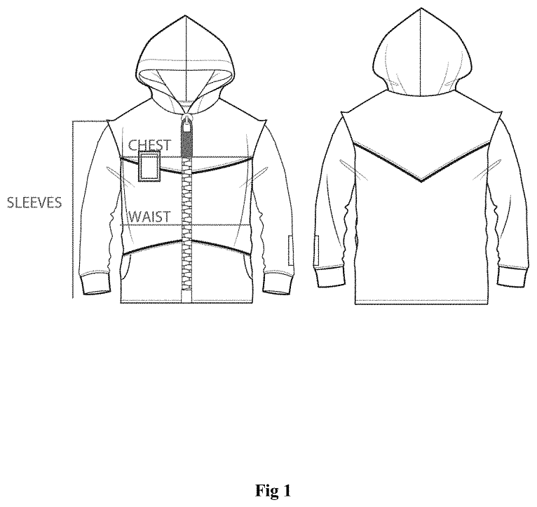

FIG. 2 illustrates the bar code view in accordance with an embodiment of the present disclosure.

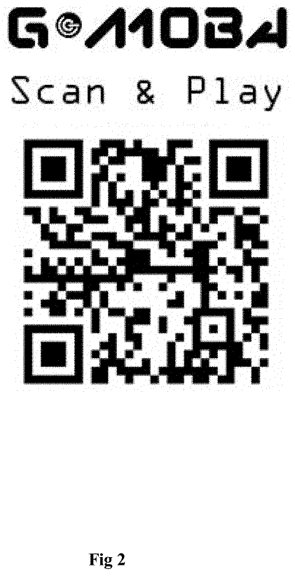

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting but rather as a basis for the claims and as a representative basis for teaching one skilled in the art to employ the present invention in virtually any appropriately detailed system, structure or manner.

Detailed descriptions of the preferred embodiment are provided herein. It is to be understood, however, that the present invention may be embodied in various forms. Therefore, specific details disclosed herein are not to be interpreted as limiting but rather as a basis for the claims and as a representative basis for teaching one skilled in the art to employ the present invention in virtually any appropriately detailed system, structure or manner.

Typically the format of QR code is a square matrix of black and white or any other color in form of small squares, surrounded by a white border. It can be 21 by 21, 25 by 25 and bigger. Usually, format 25 is enough to encode a short URL on a 7% error correction level. Although format 21 is better in terms of real-life conditions scan ability, they can only encode a limited amount of combinations that may not be enough for practical use.

The present invention is based on connecting users to gaming and entertainment services through their smartphones and other related portable computing devices using QR codes current on their wearable garments and items. After being scanned by their mobiles, the QR code would grant them access to the requested service using the Internet. In one or more aspects of the present invention, a user's electronic computing device with a computer program product installed upon it (e.g. “mobile app”) is utilized to access and use a gaming or other entertainment services like videos, songs, product information etc. by scanning the QR code present on their garments.

The QR code shall be printed or embedded on users' jacket, t-shirts or other wearable garments. In future, the same would be embedded on bracelets for use. The invention shall allow users to connect to the gaming and entertainment services, through which they can watch movies, videos or play games at any time and place. The scanning shall require an internet facility through their mobile service or wireless connectivity. The code is advertised with an enticement to scan for different games and entertainment services.

One of the invention's embodiments is to allow the users to play games from remote locations and gain secure access through QR code present on their wearable. In the future, many operators and companies can benefit from the invention by providing Internet-based connectivity through the transmission of the QR code data.

The invention method is to scan the QR code, which further connects the user to multiple services. The data is then appended to a Uniform Resource Locator (URL) that contains information required to access a server. The appended text conforms to the URL standard and thus forms part of a longer URL. The QR code, i.e., a Quick Response code, is a two-dimensional barcode that shall be present on the garments or other wearable items of the user would be read, e.g., by correspondingly equipped cellular phones or other mobile computing devices. The method is based on accessing multiple data through applications present on cell phones over the Internet using the QR code. The invention is based on informational carriers known to have an informational symbol, a QR code, visible from the outside, and are suitable for changing the information that is visible from the outside. Information devices cannot read it.

According to the invention with a QR code, a carrier element is provided with a theme-based jacket, t-shirt or any other related garment as a decorative design. The decorative area is sub-divided into an inner area with the QR code and an outer area adjacent to the inner area and partially surrounds this inner area. In the outer area, the decorative design has an exterior design with pattern sections assembled from QR codes elements. Placement of the QR code on the wearable items is done to scan from a mobile computing device is easy and accessible.

The QR code contains encoded data, including information about the game or entertainment service such as software and serial numbers. The user scans the QR code using a scanning device such as a scanner or a smartphone with scanning capabilities. The scanned QR code launches a web browser or application using the phone's network connection or wireless Internet to connect to a server. The server receives the data encoded in the QR code, decodes the QR Code data, parses the data, and saves future use. Optionally, the phone screen can then display to the user selected data in the QR code.

One of the invention's objectives is to provide a new style of wearable garments embedded with technology. A QR Code on the jacket or T-shirt helps the user to stand out from the crowd. It does not only make the garment different but also adds the element of technology to it. Hence, it attracts attention from others.

This detailed description connected with the drawings is intended principally as a description of the invention's presently preferred embodiments. It is not intended to represent the only form in which the present invention may be constructed or utilized. The description sets forth the designs, functions, means, and methods of implementing the invention connected with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

Having described the invention in detail, those skilled in the art will appreciate that modifications may be made to the invention without departing from its spirit. Therefore, it is not intended that the invention's scope be limited to the specific embodiment illustrated and described. Instead, it is intended that the appended claims and their equivalents determine the scope of this invention.

The invention claimed is:

1. A QR Code embedded on different wearable garments and items allowing users to scan gaming and entertainment application through their mobile phones or other related mobile computing devices for playing games, watching videos and other related activities.

2. As per claim 1, game-themed garments, including jackets and t-shirts having QR Codes on them.

3. As per claim 1, QR Codes on garments give users access to play games and watch videos.

4. As per claim 1, wearable garments allow users to scan QR codes embedded on their portable mobile devices.

5. As per claim 1, user can have access to gaming and entertainment sources at any remote location.

6. As per claim 1, users can play games and watch videos on their portable mobile computing devices through relevant apps connecting them to the servers through the OR Codes.

2. An entertainment method with QR codes on clothing articles comprising:
As per claim 2, clothing article with OR code;
As per claim 2, user wearing the clothing article;
As per claim 2, user having a smart device
As per claim 2, the optical sensor producing image data from the QR code corresponding to multiple games and entertainment sources;
As per claim 2, using said discerned digital information to access a remote data store;
As per claim 2, creating a direct link to the host server to receive data; and
As per claim 2, establishing communication with the person and providing them the desired games and entertainment packages.
